(19) United States
(12) Patent Application Publication
(10) Pub. No.: US 2004/0210845 A1
(43) Pub. Date: Oct. 21, 2004

(54) Internet presentation system

(76) Inventors: Glenn Paul, Titusville, NJ (US); Walter J. Krieg, Princeton, NJ (US)

Correspondence Address: Richard C. Woodbridge, Esq., Synnestvedt Lechner & Woodbridge, LLP, P.O. Box 592, Princeton, NJ, 08542-0592, US

(21) Appl. No.: 10/842,225

(22) Filed: May 10, 2004

Related U.S. Application Data
(63) Continuation-in-part of application No. 09/837,392, filed on Apr. 18, 2001.
(60) Provisional application No. 60/198,098, filed on Apr. 18, 2000.

(51) Int. Cl. G09G 5/00

(52) U.S. Cl. 715/731

(57) ABSTRACT

A software system for use on the Internet that allows users to create view slide-shows of stored digital photographs from any Internet access platform, including cellular phones. The slide-show may contain image and audio elements, as well as dividers containing text, and are presented with a selection of transitions. The system allows viewing of any album of stored graphic as a slide-show, using system default selections for slide-show parameters such as presentation time and background graphics, with a single command. The system also allows for easy user creation of customized slide shows through user selection of slide-show parameters.

### CROSS REFERENCE TO RELATED APPLICATIONS

This application is a continuation in part of now abandoned, non-provisional U.S. patent application Ser. No. 09/837,392 titled “Internet Presentation System”, filed by Paul et al. on Apr. 18, 2001, the contents of which are hereby incorporated by reference.

Non-provisional U.S. patent application Ser. No. 09/837,392 claimed priority from U.S. provisional application 60/198098 entitled “Internet Presentation System” filed with the USPTO on Apr. 18, 2000, the contents of which are hereby incorporated by reference.

### FIELD OF THE INVENTION

The present invention relates to Internet presentation methods and systems that allow users to access and view digital photographs stored on web-sites, and more particularly to creating and viewing albums of digital photographs as a slide-show which may be view by a single command from any Internet access method, including a cellular phone.

### BACKGROUND OF THE INVENTION

Digital photography has become a popular way of taking photographs, and is beginning to replace conventional, film based photography. This has created two related problems. Firstly, how to obtain good quality, color prints from the digital images without the need to purchase expensive color printing systems, inks and paper. Secondly, how to view and share collections of digital photographs.

In response to the first problem, a number of web-sites, such as the web-site operated by dotPhoto Inc. of Ewing, N.J., offer users the ability to upload digital photographs to the website, and digital memory space to store these graphic images as collections, usually referred to as albums. Such websites typically also typically enable the users to view the images in allowing stored in their albums and to purchase printed copies of any images. The printed copies of the digital image are produced at facilities having industrial quality color printers, on appropriate quality paper, and then sent via regular mail to the user.

In response to the second problem of sharing digital albums of images, the web-sites enable users to e-mail the URL of the web-page containing the albums, and any necessary access authorization codes, to a third party. In this way, the third party may visit the web-page to view and purchase any pictures in the albums.

The problem remains of how to provide users with an efficient way of viewing the images in an album. This problem has become more pronounced as users move toward viewing stored photographs using wireless devices, especially cellular phones. What is needed is a simple method, such as an automatically generated slide-show, requiring minimal user interaction, and preferably with added audio and/or interwoven text, that places the images in context. There are also the related needs of either automatically generating such a slide-show from an album of graphic images, or of allowing a user to efficiently create such a slide show from selected images.

### SUMMARY OF THE INVENTION

Briefly described, the invention relates to systems and methods that allow users to access and display stored digital photographs via networks.

Digital photographs may be stored as graphic images at one or more central locations and organized as albums of related images. To view these albums a user may access a web-page via the Internet. In a preferred embodiment, the user may view the contents of one of these albums by issuing a single command to the web-page that initiates the display of the album contents as a slide-show. The slide show is a sequential display of each of the graphic images in the album in a predetermined order for a predetermined length of time.

In a further embodiment of the invention, the slide show may include divide elements containing text, modes of transitions between the graphic images, backgrounds, audio elements associated with the graphic images and zoom sequences associated with an image, all of which may be system selected defaults or chosen by the user.

In a further embodiment of the invention, the slide show may be accessed and viewed using a cellular phone.

These and other features of the invention will be more fully understood by references to the following drawings.

### BRIEF DESCRIPTION OF THE DRAWINGS

FIG. 1 is a schematic representation of a web-based digital image processing system.

FIG. 2 is a schematic representation of a web-page in accordance with the inventive concepts of one embodiment of the present invention.

FIG. 3 is a graphic representation of a web-page containing an album of thumbnail images in accordance with the inventive concepts of one embodiment of the present invention FIG. 4 is a graphic representation of a web-page containing an internet image in accordance with the inventive concepts of one embodiment of the present invention.

FIG. 5 is a schematic representation of a display in accordance with the inventive concepts of one embodiment of the present invention.

FIG. 6 is a flow diagram in accordance with the inventive concepts of one embodiment of the present invention.

FIG. 7 is a flow diagram showing slide-viewing in accordance with the inventive concepts of one embodiment of the present invention.

### DETAILED DESCRIPTION

During the course of the description, like numbers will be used to identify the like elements according to the different view which illustrate the invention.

The present invention relates to software systems and methods that allow users to access and display stored digital photographs via networks.

In a typical web-based digital photography site, the digital pictures are uploaded to the website and presented in the form of an album. Sound or audio files may be associated with each picture by using, for instance, a user's local personal computer (PC) and the PC's microphone. The pictures and audio are stored on the web-site and may be accessed by individuals who wish to view the pictures and listen to the audio. If a user chooses to make his/her files publicly accessible, the site may also provide feedback to the creator about who has viewed the presentation. Once the photos and sounds are uploaded to the web site, the order of the pictures and sounds (now integrated as a single “slide”) may be rearranged (re-ordered) for the appropriate “flow” of the presentation. Once the presentation is complete, it may be viewed in “Presentation” mode, which is a special screen that does not include editing buttons and other extraneous on-screen information. Presentation View displays buttons for viewing the presentation including “Previous”, “Next”, “Zoom” and, if sound has been added, “Play Sound.” The creator of the presentation can also e-mail an automatically coded link to another user who, upon clicking on the link, can view the presentation without logging into the site or downloading any special software. Viewers of the presentation can respond to the presentation by e-mailing a message to the creator of the presentation.

The present invention recognizes that the image is just a part of a complete presentation system incorporating sound, text, images, and feedback from people who view the presentation.

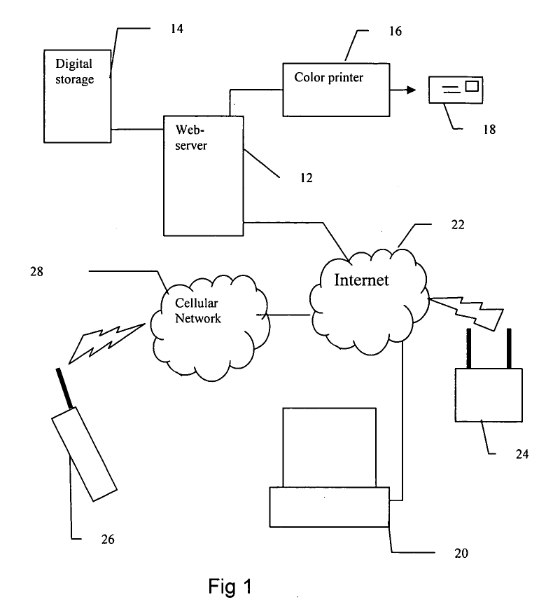

FIG. 1 shows a schematic representation of a system capable of embodying the inventive concepts of the present invention. The system comprises at least one web-server 12, a digital storage faciltiy 14, a color printing facility 16, a conventional mailing system 18, a personal computer 20, an network 22, a wireless computing device 24, a cellular phone 26 and a cellular network 28.

Web-server 12 may be any well-known computer, running software which may include an operating system module. A server module and other software modules capable of providing the web-pages that enable implementation of the Internet presentation capabilities described herein. The web-server 12 is connected to at least one digital storage facility, which may be any well-known device capable of storing digitized images. The web-server is typically also connected to a color printing device 16, capable of printing and sorting color prints. The color printing device is preferably also capable of packaging the prints, and addressing the packages so that they can be sent to the user via conventional mail.

A user may access the web-server 12 via a network 22, such as the Internet using either a personal computer 20 connected to the Internet by a direct connection such as, but not limited to, a dial up link, or a cable line, or via a wireless device, wirelessly connected to the Internet using protocols such as, but not limited to, the IEEE 802.11 a/b/g (also known as WiFi) protocols or the Bluetooth protocol.

A user may also access the web-server 12 using a cellular phone 26, which is wirelessly connected to a cellular network. The cellular network may link directly to the web-server or may link via a network such as the Internet.

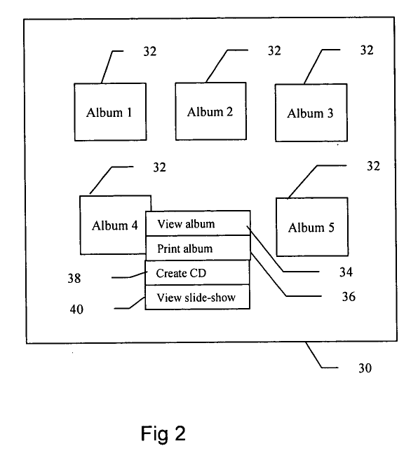

FIG. 2 shows a web-page in accordance with one embodiment of the inventive concepts of the present invention. Web-page 30, comprises one or more links to albums 32. Each link to an album 32 may have a pop-up menu containing options to, for instance, view album 34, print album 36, create CD 38, or view slide-show 40.

Web-page 30 may be in the form of a Hyper Text Markup Language (HTML) page, and may be displayed on any suitable client-side display screen, such as a conventional personal computer (PC) display. Web-page 30 may also be in a from such as, but not limited, wireless access protocol (WAP) form suitable for downloading to a mobile or cellular phone. Link to album 32 may for instance be, but is not limited to, an icon, a thumbnail image or a text box, hyper-linked to a page containing the images, or links to the images, of the album. In a preferred embodiment, selecting a particular album link 32 by for instance, moving a curser over the album link, results in an actionable pop-up menu appearing. Further movement of the cursor may select one of the actionable items, which may become highlighted. Performing a single action such as, but not limited to, a mouse-click while an actionable item is selected may result in performing that action. For instance, in a preferred embodiment of the invention, when “View slide-show” 40 is selected, a single further action such as, but not limited to, a mouse click or a voice-command, may result in the slide-show being shown.

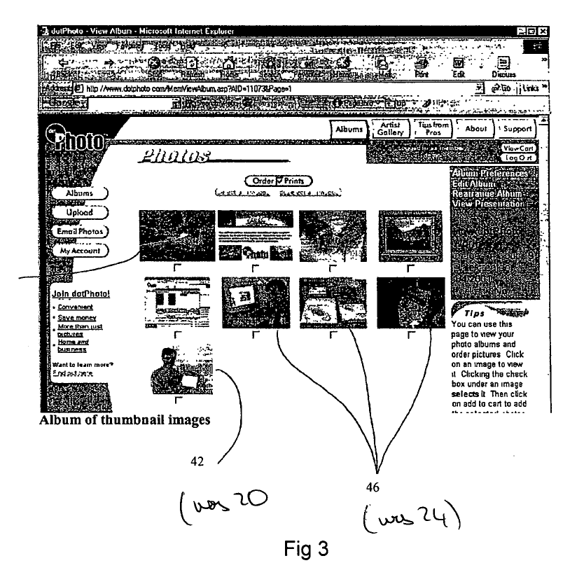

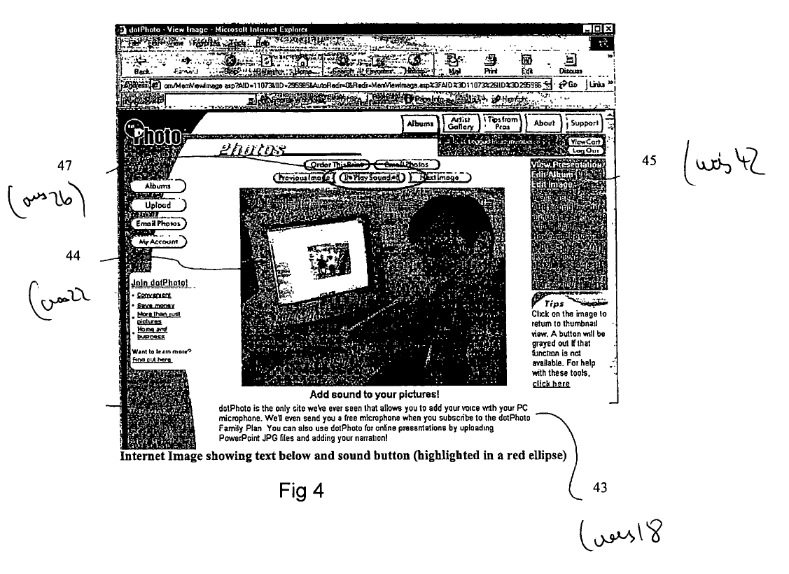

FIG. 3 shows a graphical representation of a web-page having an album of thumbnail images. Most digitized pictures are too large to display on a computer screen at the resolution at which they were captured. When a digitized picture or graphic is uploaded to the web-site, may be saved in its original digital form, and it may also be also saved in at least two other versions, such as a reduced pixel, “thumbnail” 42 representation of the original image and a larger, but lower resolution image than the original, and an “Internet image” 44, that may displayed when a user takes appropriate action such as, but not limited to, placing a cursor over a thumbnail image 42 and clicking on the thumbnail image 42.

The thumbnail images 42 are displayed in an “album” 46 which may be a group of unrelated images or a group of images related to one another, as in a business presentation or group of images related to a particular event. Clicking on one of the thumbnail images 42 displays the “Internet image” 44 and any text or sound that may be associated with that image 44. A play sound control bar 47 also pops up with the Internet image 44 and is displayed in the screen with the image 44. The text 43 and sound may simply describe the individual image 44 or help tell the story of the presentation or album 46. A User may click on the play sound button 47 to hear the sound that is associated with the image 44.

Above the Internet image 44 is displayed a list of choices 47 one of which can be selected by placing a cursor over the choice and clicking. The choices that may be used include, but are not limited to, Delete Image, Order this Print, E-mail Photos, Previous Image, Play Sound, and Next Image.

Clicking on the Delete Image button deletes the image, clicking on the Order this Print button allows the user to order a hard copy of the print, clicking on the e-mail Photos allows the user to e-mail electronic copies of the pictures in the album. The remaining buttons are self explanatory.

Next to the Internet Image 47, there may be an additional set of choices 45, which include options such as View presentation, Edit Album, Edit Image.

Clicking on the “Edit Image” choice, for example, may bring up a custom control bar that allows the user to, Record a sound, Save Text, Upload a sound or rotate a picture. Clicking on the “Record” button allows the user to record a sound using a microphone and a sound card on the local computer. The user may click the “Upload Sound” button to upload the sound file to the web site. The sound may then be associated with the image in the web site database and is available to playback when another user, who has access through a “Viewer” password, views the image 44. Text can be added by typing it into the title and description boxes and clicking on a “Save Text” button.

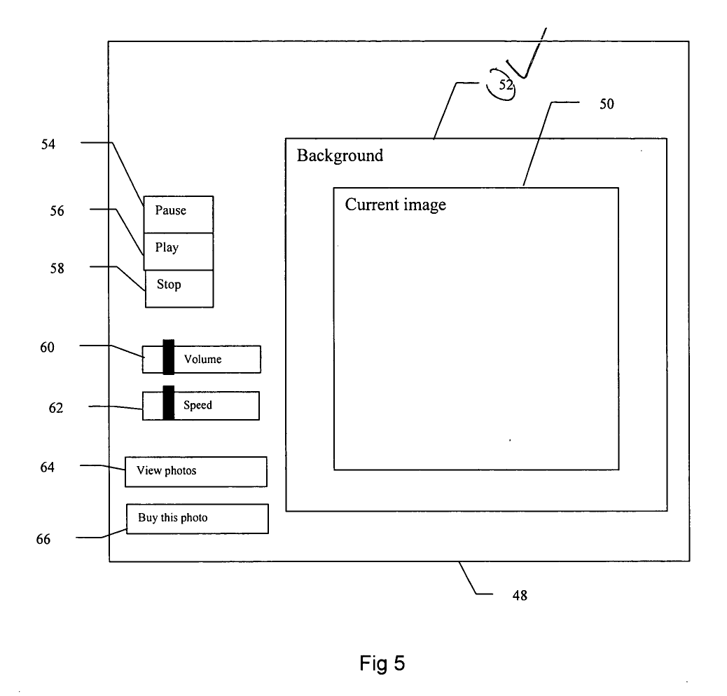

FIG. 5 shows a representation of a slide-show web-page of a further embodiment of the invention. In response to selecting and clicking on view slide show action item 40, slide-show page 48 may be displayed. Slide-show page 48 comprises a current image 50, a background image 52, a pause button 54, a play button 56, a stop button 58, a volume control 60, a speed control slide bar 62, a view photos button 64 and a buy this photo button 66.

On slide-show page 48, rather than viewing images of an album one picture at a time as described above, the image presentation may be a slide-show of all the image in album, initiated by a single command. The slide show may be a sequential display of each of the graphic images in the album in a predetermined order, each being displayed for a predetermined length of time.

The slide show may include divide elements containing text which appear between consecutive current images 50, in the same location as the current image 50. The slide show may have different modes of transition between said graphic images such as, but not limited to, fades, wipes, dissolves and cross dissolves. The slide-show may also include one or more backgrounds 52. There may also be audio elements associated with each graphic image.

In one embodiment of the invention, the order of presentation, the length of time each graphic image or other element is presented for, the divide element, the mode of transition between graphics, the background graphic and the audio elements may be selected by the system using default instances of each. In this way, any album may be presented as a slide-show at the click of a button. The default order of display may, for instance, be the order in which the image where uploaded.

In a further embodiment of the invention the order of presentation, the length of time each graphic image or other element is presented for, the divide element, the mode of transition between graphics, the background graphic and the audio elements may each be selected by the user. This may for instance be done by having a slide-builder page with graphic elements that guide the user through the steps of creating a slide show, including selection of each of the elements above.

In a further embodiment the slide show may include at least one zoom sequence associated with one of said graphic images. Such a zoom sequence may consist of a transition from one view of a single image at a particular size and resolution to another view of a portion of the same image. The portion may for instance be displayed at the same size as the whole was originally displayed, and at increased resolution, i.e., a zoom-in or enlargement transition. The zoom transition may also be a zoom-out transition or a combination of such transitions.

In one embodiment of the invention, the slide show may end with a single page display of a thumbnail image of each of the graphic images in the slide show, or a thumbnail of the graphic images and the divider elements. Such an end page may also contain links to higher resolution images of the thumbnails or buttons that allow the user to purchase one or more of the digital pictures represented by the thumbnails.

In a further embodiment of the invention, the of web site may be accessed using a cellular phone; and the slide show may occur on the cellular phone screen. This may be facilitated by converting the images in the slide show in a form suitable for viewing on a cellular phone such as, but not limited to, a WAP protocol, or a suitable Binary Runtime Environment for Wireless (BREW) such as BREW Image Compression (BIC) format or a Portable Network Graphics (PNG) format. The messaging between the cellular phone and the web server may be implemented in any suitable form such as, but not limited to, Multimedia Messaging Service (MMS) messages, or any other combination of Short Messaging Service (SMS) and WAP technologies.

The single command to activate the slide show may be a button click or an audio command, spoken by the user.

In order for the cellular phone customer to obtain the benefit of text on the dividers of slide shows, this text may be converted into an audio form and spoken to the user. For instance, the text may first be converted to electronic text using any of the well known optical character recognition programs available such as, but not limited to Omnipage™ Pro 14 package available from ScanSoft Inc., of Peabody, Mass. The digital text may then be converted to an audio stream using the text-to-voice capability of software such as, but not limited to, the Text-to-Voice package of the Paraben Corporation of Pleasant Grove, Utah.

In a further embodiment of the invention, the user may also control aspects of the slide show presentation using buttons such as the stop button 58, the pause button 54 and the play button 56. The volume of the audio of the slide show presentation may be adjusted by the user by means of, for instance, a volume slider element 60. Similarly the speed of the presentation may also be adjusted by a speed slider element 62. There may also be buttons which allow the user to view photos 64, which would take the viewer to a conventional viewing mechanism to view the photos of album. There may also be a buy this button 66, that allows the viewer to buy a photograph by adding the currently displayed image to a shopping cart, preferably without pausing the slide show presentation. That way, at the end of the viewing the user may go to their shopping cart and finalize the purchase of the images selected while viewing the slide-show.

In a further embodiment of the invention, a first user may allow their albums to be available to public viewing. The first user may also allow their albums to be accessible to only selected third parties, whom they may inform and direct to a presentation of the slide-show by, for instance, sending an e-mail or text message containing the URL of the web-page containing links to the album, along with any necessary access details such as, but not limited to, passwords.

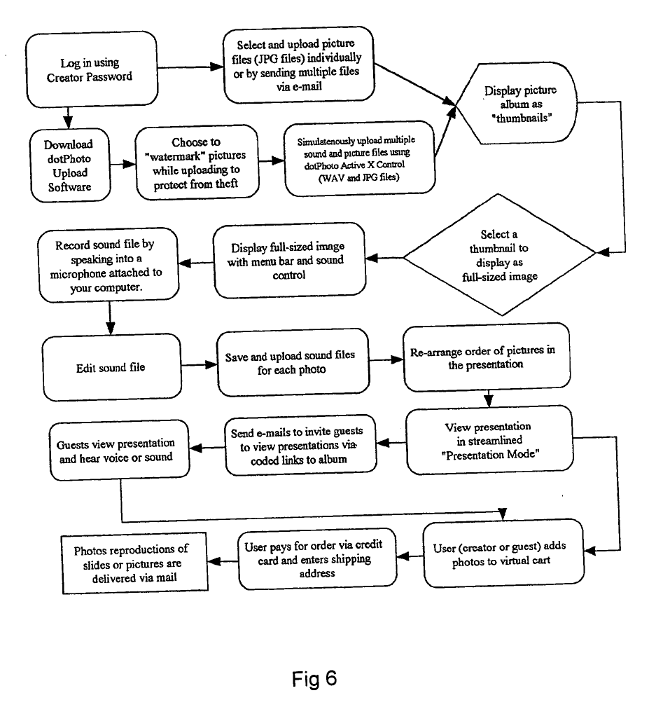

FIG. 6 is a detailed flow chart showing one embodiment of the present invention.

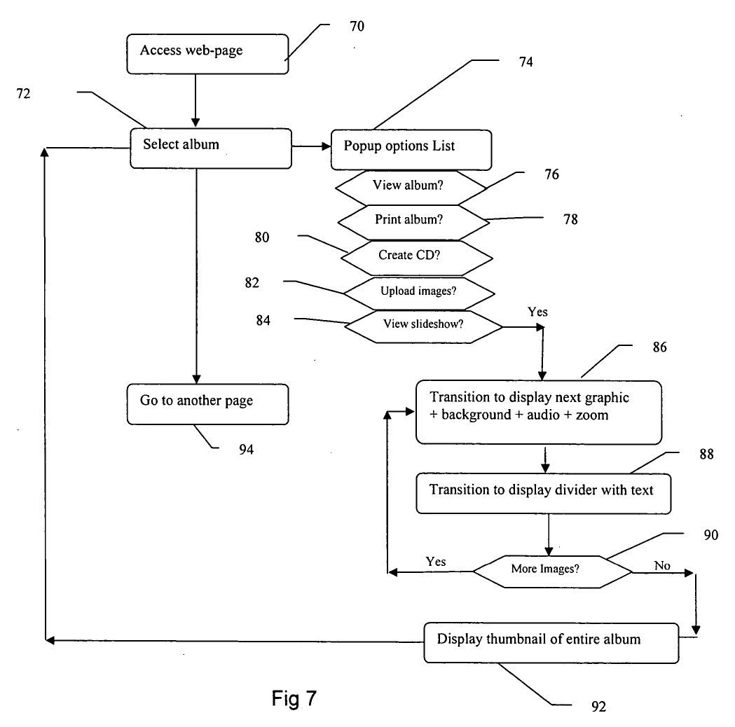

FIG. 7 is flow chart, detailing the actions involved in a view selecting and viewing a slide show. The viewer begins by accessing the web-page at step 70, at which point they are presented with a page containing links to one or more albums. In a preferred embodiment, step 72 of selecting an album is accomplished by a viewer moving a cursor over an icon or thumbnail representing a particular album. When the curser is moved over the icon or thumbnail, a popup list of options may present itself along side the icon or thumbnail in step 74. The popup options list may include choices such as, but not limited to, view album 76, print album 78, create CD 80, upload images 82 or view slide show 84. The user may select one of these options my moving the curser to highlight the particular option and then clicking a mouse button. If, for instance, the view slide-show option is selected, the single mouse click will initiate showing of the slide-show. The first step in showing the slide show is step 86 of displaying a transition to a next graphic, which is the next digital image in the presentation, along with any required background image, any audio associated with the image being displayed and any zoom transitions associated with the image. Once the image has been shown for the predetermined length of time, the system automatically moves to step 88 in which a transition to an optional display divider, containing optional text occurs. Once any display divider has been shown for a predetermined length of time, the system checks to see if there are any more graphic images to be shown. If there are more graphic images in the slide-show, the system loops back to step 86 and displays that next graphic image and all associated sound and background elements. If there are no more graphic images, the system may move to step 92, and display a single, end-of-slide show web-page containing thumbnail images of all the graphic images in the album. This page of all the thumbnails may be an end point, or it may be displayed for a predetermined time before the user is returned to the page from which they originally selected the album, at which point they have the option to select another page in step 94.

The methods and system of the invention described may implemented as software modules and web-pages, capable of being run on computer processors, by using a variety of software languages and modules including, but not limited to, HTML, C, C++, JAVA and BREW.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention

What is claimed is:

1. An image presentation method, comprising the steps of:
a) accessing a web-page containing links to at least one album, said album containing at least two graphic images in a digital format; and
b) activating a slide-show of said album by a single command, said slide show being a sequential display of each of said graphic images in a predetermined order for a predetermined length of time.

2. The method of claim 1, wherein said slide show further comprises at least one divide element containing text, at least one mode of transition between said graphic images, at least one background for graphic images and at least one audio element associated with each graphic image.

3. The method of claim 2, wherein said order, said length of time, said divide element, said mode of transition, said background graphic and said audio element are system selected defaults.

4. The method of claim 2, further comprising the step of c) selecting said order, said length of time, said divide element, said mode of transition, said background graphic and said audio element by a user.

5. The method of claim 1, wherein said step a) of accessing a web site further comprises using a cellular phone; and wherein said sequential display of said images occurs on a screen of said cellular phone.

6. The method of claim 5, wherein said single command is an audio command.

7. The method of claim 5, further comprising the step of converting said graphic images to a BREW compressed format prior to said sequential display of said images on said screen of said cellular device.

8. The method of claim 2, wherein said step a) of accessing a web site further comprises using a cellular phone; wherein said sequential display of said images occurs on a screen of said cellular phone; and further comprising the step d) of converting said text of said divider to an audio message and playing said audio message using said cellular phone.

9. The method of claim 1, further comprising the step of e) making said web-page accessible to a second user.

10. The method of claim 1, wherein said slide show further comprises at least one zoom sequence associated with one of said graphic images, said zoom sequence comprising a transition to a view of a portion of said image at an altered size.

11. The method of claim 1, further comprising the step of f) ending said slide show with a single page display of a thumbnail image of each of said one or more graphic images.

12. An image presentation system, comprising:
a web-page containing links to at least one album, said album containing at least two graphic images in a digital format; and
a web-page capable of displaying a slide-show of said album in response to a single command, said slide show being a sequential display of each of said graphic images in a predetermined order for a predetermined length of time.

13. The system of claim 12, wherein said slide show further comprises at least one divide element containing text, at least one mode of transition between said graphic images, at least one background for graphic images and at least one audio element associated with each graphic image.

14. The system of claim 13, wherein said order, said length of time, said divide element, said mode of transition, said background graphic and said audio element are system selected defaults.

15. The system of claim 13, further comprising a web-page capable of allowing a user to select said order, said length of time, said divide element, said mode of transition, said background graphic and said audio element.

16. The system of claim 12, further comprising a cellular phone; and wherein said sequential display of said images occurs on a screen of said cellular phone.

17. The system of claim 16, wherein said single command is an audio command.

18. The system of claim 13, further comprising a cellular phone; wherein said sequential display of said images occurs on a screen of said cellular phone; and further comprising a text-to-audio message converter and wherein said audio message is converted message is played by said cellular phone.

19. The system of claim 12, wherein said slide show further comprises at least one zoom sequence associated with one of said graphic images, said zoom sequence comprising a transition to a view of a portion of said image at an altered size.

20. The method of claim 12, further comprising and end-of-slide show web-page comprising a display of a thumbnail image of each of said one or more graphic images.
